(19) United States
(12) Patent Application Publication
(10) Pub. No.: US 2020/0262723 A1
(43) Pub. Date: Aug. 20, 2020

(54) METHOD FOR REMOVING PPCPS IN DRINKING WATER TREATMENT PROCESS

(71) Applicant: Tsinghua University, Beijing (CN)

(72) Inventors: Yujue WANG, Beijing (CN); Hongwei YANG, Beijing (CN); Yongkun LI, Beijing (CN); Weikun YAO, Beijing (CN); Xiaofeng WANG, Beijing (CN)

(21) Appl. No.: 16/061,331

(22) PCT Filed: Feb. 14, 2016
(86) PCT No.: PCT/CN2016/073757

§ 371 Date: Jun. 11, 2018

(30) Foreign Application Priority Data
Feb. 11, 2015 (CN) 201510073152.9

(51) Int. Cl. C02F 1/467; C02F 1/78; C02F 1/72

(52) U.S. Cl. CPC C02F 1/4672; C02F 2103/343; C02F 1/727; C02F 1/78

(57) ABSTRACT

A method for removing PPCPs in a drinking water treatment process, includes the following operations: introducing, by using a manner of bottom microporous aeration, a mixture gas of O₂ and O₃ in which a volume percentage of O₃ is 5% to 10% to an ozone contact reaction column (1) in which a cathode (3) and an anode (2) are disposed at the bottom, and a direct current is applied to the cathode and the anode; while the mixture gas is being introduced, adding, to the ozone contact reaction column (1), PPCPs containing water to be treated, with a hydraulic retention time of 10 s to 40 min, and discharging the water in real time. Further disclosed is the use of the method for removing PPCPs in a drinking water treatment process in preparation of drinking water.

### TECHNICAL FIELD

The present invention relates to the field of water treatment, in particular to a method for removing PPCPs in a drinking water treatment process.

### BACKGROUND ART

Pharmaceuticals and Personal Care Products (PPCPs) include a series of chemicals including various drugs (such as antibiotics, antineoplastic drugs, anxiolytic and anticonvulsive drugs, hormone drugs, blockers and sympathomimetic drugs, anti-inflammatory drugs, diet pills, analgesics, antihypertensives, contraceptives, antidepressants, etc.) and personal care products (such as soap, shampoo, toothpaste, perfume, skin care product, hair gel, hair dye, hair conditioner, etc.), which are closely related to human life. With the improvement of people's life and medical level, PPCPs are widely used. Most of the drugs administrated to human or animal bodies cannot be completely absorbed by the body, and are mostly excreted in the original form or in the form of metabolite into the environment with feces, urine, etc. In addition, most personal care products also enter directly to the environment during use.

PPCPs that enter the environment may interfere with the normal growth of organisms in the environment, cause biological aberration or mutation, and induce the production of numerous drug-resistant strains. With the deepening of people's understanding of the potential hazards of PPCPs to the environment and humans, an increasing number of scholars have begun to pay attention to the handling of PPCPs in various processes. The general process of traditional sewage treatment process is: coagulation-precipitation-filtration-disinfection. These conventional treatment processes are not performed specifically for PPCPs, so the PPCPs removal effect is not good, and the removal rate of most PPCPs does not reach 50% or even they cannot be degraded. It happens occasionally that the concentration of PPCPs in the effluent water of the water plant exceeds the standard of the “Sanitary Standard for Drinking Water” (GB5750-2012) issued by the Ministry of Health of China, which seriously threatens the drinking water safety of the people.

At present, there are few treatment processes for PPCPs in drinking water, mainly including ozone-activated carbon adsorption process, but for some highly stable PPCPs, such as ibuprofen, primidone, clofibric acid, iopromide, diclofenac and the like, the removal rate by ozone oxidation alone is very low. In addition, ozone oxidation can generate oxidative by-products such as bromate and formaldehyde that are seriously harmful to human body, which makes the widespread use of ozone in question.

Compared to ozone oxidation alone, O₃/H₂O₂ advanced oxidation process has the advantages of simple operation, strong oxidizing ability, low cost and no secondary pollution. It has broad application prospects in the field of water supply and wastewater treatment, and is one of the technologies worth considering. However, through the coupling of additional H₂O₂ and O₃ to produce strongly oxidizing .OH, the operation process is complicated and cause a little danger; secondly, a large amount of O₂ is wasted in the process of O₃ generation, and high energy consumption and waste occur in the process.

### SUMMARY OF THE INVENTION

In order to solve the above problems, the present invention provides a method for effectively removing PPCPs in drinking water treatment process; the method combines ozone oxidation with an electrochemical method, has the features of no need for organic carbon sources, strong redox ability and the like, and is a method for efficiently treating organic micro-pollutants.

The present invention adopts the following principle: in a direct current electric field, O₂ dissolved in water undergoes a in-situ electrochemical reaction for the generation of H₂O₂ at the bottom of an ozone contactor, and the reaction equation is: O₂+2H⁺+2e⁻→H₂O₂; the generated H₂O₂ can further undergo a Peroxone reaction with O₃ dissolved in the solution, resulting in a strongly oxidizing hydroxyl radicals (.OH), which oxidatively degrades PPCPs.

Specifically, the present invention provides a method for removing PPCPs in a drinking water treatment process, and the method comprises the following operations:

introducing, by using a manner of bottom microporous aeration, a mixed gas of O₂ and O₃ in which a volume percentage of O₃ is 5% to 10% to an ozone contact column, at the bottom of which a cathode and an anode are disposed and a direct current is applied to the cathode and the anode; while the mixed gas is being introduced, adding PPCPs-containing water to be treated to the ozone contact column, with a hydraulic retention time of 10 s to 40 min, and discharging water in real time.

The method provided by the invention can effectively remove PPCPs micro-pollutants in the water, including ibuprofen, diclofenac, diazepam, iopromide, meprobamate, primidone, and clofibric acid. Before and after the water treatment, the concentration of PPCPs can be measured by any method in the prior art. For example, the concentration of PPCPs can be measured by solid phase extraction-high performance liquid chromatography-electrospray tandem mass spectrometry (SPE-HPLC-MS/MS).

The water to be treated according to the present invention is obtained after the surface water or the groundwater is subjected to conventional drinking water pretreatments such as flocculation, precipitation, filtration and the like. In the water to be treated according to the present invention, the concentration of PPCPs is 0.01 ng/L to 20 μg/L, the total organic carbon content (TOC) is 0 to 10 mg/L, the pH is 2 to 12, and the conductivity is greater than 300 μS/m.

The water to be treated preferably has a PPCPs concentration of 2 to 100 ng/L, a TOC of 0 to 6.3 mg/L, a pH of 4.0 to 10.5, and conductivity greater than 300 μS/m.

In the present invention, the water to be treated is added into the ozone contact column in the manner of gas-liquid cocurrent flow at the bottom or counter flow feeding at the top.

In a direct current electric field, the O₂ dissolved in the water undergoes a in-situ electrochemical reaction for the generation of H₂O₂ at the bottom of an ozone contactor. Therefore, the amount of the H₂O₂ generated can be adjusted by adjusting the current density of the in-situ electrochemical reaction, and thereby the ratio of the concentration of H₂O₂ to the concentration of O₃ in the water can be adjusted. According to the characteristics of the surface water to be treated and various index parameters, the invention optimizes the gas inlet amount and the current density so that the ratio of the concentrations of H₂O₂ to O₃ in the water reaches a reasonable range, thereby effectively removing the PPCPs in the water. Specifically, the ratio of the amount of the introduced O₃ to the volume of the water to be treated is 0.1 to 10 mg/L, preferably 1.8 to 6.2 mg/L; and the current density at the cathode is 0.1 to 20 mA/cm², preferably 3 to 7 mA/cm².

In the present invention, the amount of the introduced O₃ can be measured by using any conventional technical means existing in the field, and the present invention does not limit the measuring method. As a preferred solution, the amount of the introduced O₃ can be measured by the KI absorption method, which comprises the following specific procedures: a mixed gas having the same composition as the present invention is introduced into the KI solution in the same amount as the present invention, and the color of the solution changes; after O₃ is absorbed by the KI solution, the solution is reversely titrated with sodium thiosulfate until a reverse change of the color of the solution occurs, and the amount of the introduced O₃ can be indirectly obtained by calculating based on the amount of sodium thiosulfate.

The mixed gas of the present invention can be obtained by directly mixing O₂ with O₃, and can also be prepared by other methods, preferably prepared with an ozone generator. The specific steps for preparation with an ozone generator are as follows: O₂ is introduced into the ozone generator, a part of O₂ is converted into O₃, and the output gas is a mixed gas of O₂ and O₃ in which a volume percentage of O₃ is 5% to 10%.

When the mixed gas of O₃ and O₂ is introduced into the ozone contact column, the aeration method is bottom microporous aeration, and the flow rate of the microporous aeration is 0.01 L/min to 10 L/min. Such aeration method disperses the gas that enters the ozone contact column as microbubbles, which can better contact with the water in the ozone contact column. At the same time, the H₂O₂ generated at the bottom diffuses toward the top of the ozone contact column under the entrainment by the gas, and can react better with O₃. A glass sand core can be provided at the bottom of the ozone contact column, after the mixed gas passes through the glass sand core, it becomes microbubbles, and can be in full contact with the liquid in the ozone contact column, which is favorable for mass transfer.

In the electrodes of the present invention, the anode area is 5 cm² to 20 cm², and the anode is selected from the group consisting of Pt electrode, graphite electrode, boron-doped diamond electrode, Pt/C electrode, ruthenium-iridium-plated titanium electrode, ruthenium-plated titanium electrode, platinum-plated titanium electrode, iridium-plated titanium-based electrode, rhodium-plated titanium-based electrode, iridium dioxide-plated titanium-based electrode, stainless steel electrode, nickel electrode, and alloy electrode containing two or more transition metals; the alloy electrode containing two or more transition metals is an aluminum alloy electrode, a titanium alloy electrode, a copper alloy electrode or a zinc alloy electrode. The anode is preferably a Pt plate electrode or a ruthenium-iridium-plated titanium electrode with an area of 20 cm². The anode used in the present invention can reduce the overpotential of the reaction, and facilitate the evolution of O₂ and the generation of H⁺, thereby reducing the applied voltage and energy consumption.

In the electrodes of the present invention: the cathode area is 5 cm² to 20 cm²; the cathode is selected from the group consisting of graphite electrode, glassy carbon electrode, activated carbon fiber electrode and gas diffusion electrode; the gas diffusion electrode is carbon paper/cloth/felt-polytetrafluoroethylene electrode, activated carbon-polytetrafluoroethylene electrode, carbon black-polytetrafluoroethylene electrode, carbon nanotube-polytetrafluoroethylene electrode, or graphene-polytetrafluoroethylene electrode; wherein, carbon paper/cloth/felt-polytetrafluoroethylene electrode is a carbon paper-polytetrafluoroethylene electrode or a cloth-polytetrafluoroethylene electrode or a felt-polytetrafluoroethylene electrode. The cathode is preferably a carbon paper-polytetrafluoroethylene electrode, or a graphite electrode with an area of 20 cm². The cathode used in the present invention enables selective reaction of O₂ with H⁺ to generate H₂O₂ rather than H₂₀.

The electrodes used in the present invention exist in a large number in the market, for example, the electrodes can be selected from the electrodes produced by Suzhou Borui Industrial Material Technology Co., Ltd., Baoji Changli Special Metal Co., Ltd., Baoji Zhiming Special Metal Co., Ltd., and Shanghai Hesen Electric Co., Ltd.

The power supply used in the present invention is an ordinary direct current voltage-stabilized power supply.

The device used in the present invention preferably includes the following components: an ozone generator, a glass sand core, a direct current power supply, a cathode, an anode, and an ozone contact column. The ozone generator is connected with the ozone contact column, the glass sand core is provided at the bottom of the ozone contact column, the cathode and the anode are fixed above the glass sand core, and the anode and the cathode are connected to the positive electrode and the negative electrode of the direct current power supply, respectively.

Wherein, the glass sand core is a glassy and spongy solid with messy pore passages therein. The O₃ and O₂ from the ozone generator turn into microbubbles after passing through the glass sand core, and the diameter of the microbubbles is less than 1 mm, such that the microbubbles can be in full contact with the liquid in the ozone contact column, which is favorable for mass transfer. The glass sand core can also be replaced by stainless steel and other corrosion-resistant ceramic materials, anti-oxidation materials such as polytetrafluoroethylene, and gas distribution plate commonly used for engineering, such as microporous titanium gas distribution plate.

The hydraulic retention time (HRT) of the present invention refers to the average retention time of the water to be treated in the reactor. In the solution provided by the present invention, the water to be treated needs only a short retention time in the reactor to achieve high-efficiency removal of the PPCPs micro-pollutants. Considering many factors such as the removal efficiency of PPCPs micro-pollutants and the time cost, the hydraulic retention time is preferably 10 to 20 min, and more preferably 20 min.

In the actual production process, the operations such as introducing the mixed gas into the ozone contact column, applying direct current to the electrodes at two ends, adding the water to be treated to the ozone contact column, and discharging water and the like can be operated in a continuous mode with a constant rate, or operated an intermittent mode.

The present invention further provides the use of the method in the production of drinking water. In the actual production process, the water treated according to the method provided by the present invention can enter the pipe network after chlorine disinfection.

Compared with the traditional method for removing the PPCPs in drinking water treatment process, such as the biofilm method, the electrochemical method, adding .OH scavenger, catalytic ozonation and the like, the present invention has the following unique advantages and beneficial effects: (1) no additional chemical agent is required, which can greatly reduce the treatment cost. (2) H₂O₂ is generated electrochemically in situ, which improves safety and makes the process easy to control. In addition, the H₂O₂ electrochemically generated in situ sufficiently reacts with the O₃ entering the ozone contact column, which increases the reaction efficiency. (3) The method provided by the present invention can effectively remove the PPCPs that are typically difficult to degrade in the water to be treated in a short time. (4) The treatment process is clean, without generation of flocculent precipitates or secondary pollution, and can be combined with other drinking water treatment technologies to improve treatment efficiency. It can be seen that, the present invention provides a method for efficiently removing PPCPs in a drinking water treatment process, and has a good development and application prospect.

### BRIEF DESCRIPTION OF THE DRAWINGS

FIG. 1 is a schematic diagram of a device used in Examples of the present invention; in this FIGURE, 1 represents a reaction column; 2 represents an anode; 3 represents a cathode; 4 represents a water inlet; 5 represents a water outlet; 6 represents a gas distribution plate; 7 represents an air inlet; 8 represents an air outlet; 9 represents peristaltic pump; 10 represents a direct current power supply; 11 represents an ozone generator; 12 represents an ozone detector; 13 represents a water tank; and 14 represents an oxygen cylinder.

### SPECIFIC MODES FOR CARRYING OUT THE EMBODIMENTS

The following examples are intended to illustrate the present invention but are not intended to limit the scope of the present invention. If not specified, the technical means used in Examples are conventional means well known to a person skilled in the art.

The water bodies to be treated in each embodiment are surface water taken from a reservoir in Beijing and treated by precipitation. The initial concentration of PPCPs in each Example was controlled within a range of 2 to 100 ng/L, which covering the concentration range of PPCPs in surface water or groundwater in general suburbs.

### Example 1

In the water body to be treated, the initial TOC value was 2.8 mg/L and the initial pH was 8.0.

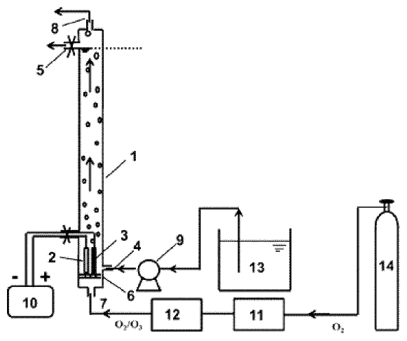

The device used in this Example was shown in FIG. 1.

The water body was treated according to the following operations:

O₂ was introduced into an ozone generator to obtain a mixed gas of O₂ and O₃ in which a volume percentage of O₃ is 10%. By using a manner of bottom microporous aeration, the mixed gas was introduced continuously at a constant rate to an ozone contact column, in which a cathode and an anode are disposed at the bottom and a direct current is applied to the cathode and the anode; while the mixed gas is being introduced, the PPCPs-containing water body to be treated was injected continuously at a constant rate to the ozone contact column with a hydraulic retention time of 20 min, and the water body was discharged in real time.

The ratio of the amount of the introduced O₃ to the volume of the water to be treated is 3.2 mg/L;

The anode is a Pt plate electrode with an area of 20 cm² (purchased from Suzhou Borui Industrial Material Technology Co., Ltd.), and the cathode is a carbon paper-polytetrafluoroethylene electrode with an area of 20 cm² (purchased from Shanghai Hesen Electric Co., Ltd.); A direct current was continuously applied to the cathode and the anode with a current density of 4 mA/cm².

After detection, the concentrations of typical PPCPs before and after treatment were shown in Table 1.

TABLE 1
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 6.4 | 7.6 | 9.5 | 9.8 | 8.7 | 5.1 | 7.9 |
| after treatment | | | | | | | |

By detecting at the water outlet, it was found that there was no residual H₂O₂ in the water after the reaction (the water after the reaction was taken and reacted with titanium potassium oxalate, the absorbance was measured, and it was confirmed that there was no H₂O₂), hence the corrosion problem of the pipe network caused by H₂O₂ will not occur.

The unreacted O₂ and O₃ were collected at an exhaust gas outlet and re-introduced into the ozone generator to produce the mixed gas of O₂ and O₃ so as to reduce gas consumption.

### Example 2

In the water body to be treated, the initial TOC value was 2.8 mg/L and the initial pH was 8.0.

Compared with Example 1, the difference in the treatment method lied in that the current density was 2 mA/cm².

After detection, the concentrations of typical PPCPs before and after treatment were shown in Table 2.

TABLE 2
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 12.1 | 15.3 | 23.3 | 24.1 | 19.8 | 10.3 | 17.8 |
| after treatment | | | | | | | |

### Example 3

In the water body to be treated, the initial TOC value was 2.8 mg/L and the initial pH was 8.0.

Compared with Example 1, the difference in the treatment method lied in that the current density was 5 mA/cm².

After detection, the concentrations of typical PPCPs before and after treatment were shown in Table 3.

TABLE 3
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | <0.1 | 3.2 | 4.1 | 4.8 | 3.9 | <0.1 | 3.5 |
| after treatment | | | | | | | |

### Example 4

In the water body to be treated, the initial TOC value was 2.8 mg/L and the initial pH was 4.03.

Compared with Example 1, the difference in the treatment method lied in that a Pt plate electrode with an area of 20 cm² was used as the anode, and a graphite electrode with an area of 20 cm² (purchased from Shanghai Hesen Electric Co., Ltd.) was used as cathode.

After detection, the concentrations of typical PPCPs before and after treatment were shown in Table 4.

TABLE 4
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 7.1 | 7.9 | 9.6 | 9.7 | 8.9 | 6.4 | 8.3 |
| after treatment | | | | | | | |

### Example 5

In the water body to be treated, the initial TOC value was 2.8 mg/L and the initial pH value was 8.25.

The treatment method was the same as that in Example 4.

After detection, the concentrations of typical PPCPs before and after treatment were shown in Table 5.

TABLE 5
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 6.3 | 7.7 | 9.4 | 9.6 | 8.5 | 5.8 | 8.3 |
| after treatment | | | | | | | |

### Example 6

In the water body to be treated, the initial TOC value was 2.8 mg/L and the initial pH was 10.25.

The treatment method is the same as that in Example 4.

After detection, the concentrations of typical PPCPs before and after treatment were shown in Table 6.

TABLE 6
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before treatment | | | | | | | |
| Concentration | 6.9 | 7.9 | 9.4 | 9.6 | 8.9 | 6.3 | 7.9 |
| after treatment | | | | | | | |

### Example 7

In the water body to be treated, the initial TOC value was 2.05 mg/L and the initial pH was 8.0.

Compared with Example 1, the difference in the treatment method lied in that the anode was a Pt plate electrode with an area of 20 cm², and the cathode was a carbon black-polytetrafluoroethylene electrode with an area of 20 cm².

After detection, all the concentrations of ibuprofen, diclofenac, diazepam, iopromide, meprobamate, primidone, and clofibric acid in the water before treatment were 100 ng/L; and all of the concentrations of PPCPs in the treated water body were less than 5 ng/L.

### Example 8

In the water body to be treated, the initial TOC value was 4.2 mg/L and the initial pH was 8.0.

The treatment method was the same as that in Example 7.

After detection, all the concentrations of ibuprofen, diclofenac, diazepam, iopromide, meprobamate, primidone, and clofibric acid in the water before treatment were 100 ng/L; and all the concentrations of PPCPs in the treated water body were less than 10 ng/L.

### Example 9

In the water body to be treated, the initial TOC value was 6.3 mg/L and the initial pH was 8.0.

The treatment method was the same as that in Example 7.

After detection, all the concentrations of ibuprofen, diclofenac, diazepam, iopromide, meprobamate, primidone, and clofibric acid in the water before treatment were 100 ng/L; and all the concentrations of PPCPs in the treated water body were less than 10 ng/L.

### Example 10

In the water body to be treated, the initial TOC value was 2.8 mg/L and the initial pH was 8.0.

Compared with Example 1, the difference in the treatment method lied in that the anode was a ruthenium-iridium-plated titanium electrode with an area of 20 cm² (purchased from Suzhou Bo Rui Industrial Material Technology Co., Ltd.), the cathode was a carbon paper-polytetrafluoroethylene electrode with an area of 20 cm² (purchased from Shanghai Hesen Electric Co., Ltd.), and the current density was 5 mA/cm².

After detection, all the concentrations of ibuprofen, diclofenac, diazepam, iopromide, meprobamate, primidone, and clofibric acid in the water before treatment were 2 ng/L; and no PPCPs could be detected in the treated water. It can be seen that, the method provided by the present invention can efficiently and thoroughly remove low-concentration PPCPs in water body.

### Example 11

In the water body to be treated, the initial TOC value was 2.8 mg/L and the initial pH was 8.0.

The treatment method was the same as that in Example 10.

After detection, the concentrations of typical PPCPs before and after treatment were shown in Table 7.

TABLE 7
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 50 | 50 | 50 | 50 | 50 | 50 | 50 |
| before treatment | | | | | | | |
| Concentration | 1.4 | 1.8 | 2.3 | 2.4 | 2.1 | 1.3 | 1.9 |
| after treatment | | | | | | | |

### Example 12

In the water to be treated, the initial TOC value was 2.8 mg/L and the initial pH value was 8.0.

The treatment method was the same as that in Example 10.

After detection, the concentrations of typical PPCPs before and after treatment were shown in Table 8.

TABLE 8
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 10 | 10 | 10 | 10 | 10 | 10 | 10 |
| before | | | | | | | |
| treatment | | | | | | | |
| Concentration | <0.1 | <0.1 | 0.8 | 0.8 | 0.7 | <0.1 | 0.5 |
| after treatment | | | | | | | |

### Example 13

In the water body to be treated, the initial TOC value was 2.8 mg/L and the initial pH was 8.0.

The treatment method was the same as that in Example 10.

After detection, all the concentrations of ibuprofen, diclofenac, diazepam, iopromide, meprobamate, primidone, and clofibric acid in the water before treatment were 100 ng/L; and all the concentrations of PPCPs in the treated water body were less than 5 ng/L.

### Example 14

In the water body to be treated, the initial TOC value was 2.8 mg/L and the initial pH was 8.0.

Compared with Example 1, the difference in the treatment method lied in that in this Example, the anode was a ruthenium-iridium-plated titanium electrode with an area of 20 cm², and the cathode was a carbon paper-polytetrafluoroethylene electrode with an area of 20 cm²; the ratio of the amount of the introduced O₃ to the volume of the surface water to be treated was 1.8 mg/L, and a direct current was applied to the cathode and the anode with a current density of 3 mA/cm².

After detection, the concentrations of typical PPCPs before and after treatment were shown in Table 9.

TABLE 9
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 7.4 | 7.8 | 9.6 | 9.7 | 8.9 | 7.1 | 8.1 |
| after treatment | | | | | | | |

### Example 15

In the water body to be treated, the initial TOC value was 2.8 mg/L and the initial pH was 8.0.

Compared with Example 1, the difference in the treatment method lied in that in this Example, the anode was a ruthenium-iridium-plated titanium electrode with an area of 20 cm², and the cathode was a carbon paper-polytetrafluoroethylene electrode with an area of 20 cm²; the ratio of the amount of the introduced O₃ to the volume of the surface water to be treated was 2.8 mg/L, and a direct current was applied to the cathode and the anode with a current density of 3 mA/cm².

After detection, the concentrations of typical PPCPs before and after treatment were shown in Table 10.

TABLE 10
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | 7.4 | 7.9 | 9.7 | 9.9 | 8.9 | 6.9 | 7.8 |
| after treatment | | | | | | | |

### Example 16

In the water body to be treated, the initial TOC value was 2.8 mg/L and the initial pH was 8.0.

Compared with Example 1, the difference in the treatment method lied in that: in this Example, the anode was a ruthenium-iridium-plated titanium electrode with an area of 20 cm², and the cathode was a carbon paper-polytetrafluoroethylene electrode with an area of 20 cm²; the ratio of the amount of the introduced O₃ to the volume of the surface water to be treated was 4.1 mg/L, and a direct current was applied to the cathode and the anode with a current density of 6 mA/cm².

After detection, the concentrations of typical PPCPs before and after treatment were shown in Table 11.

TABLE 11
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | <0.1 | <0.1 | 4.5 | 4.8 | 3.7 | <0.1 | 2.9 |
| after treatment | | | | | | | |

### Example 17

In the water body to be treated, the initial TOC value was 2.8 mg/L and the initial pH was 8.0.

Compared with Example 1, the difference in the treatment method lied in that in this Example, the anode was a ruthenium-iridium-plated titanium electrode with an area of 20 cm², and the cathode was a carbon paper-polytetrafluoroethylene electrode with an area of 20 cm²; the ratio of the amount of the introduced O₃ to the volume of the surface water to be treated was 6.2 mg/L, and a direct current was applied to the cathode and the anode with a current density of 7 mA/cm².

After detection, the concentrations of typical PPCPs before and after treatment were shown in Table 12.

TABLE 12
Concentrations of typical PPCPs before and after treatment (ng/L)

| | | | | | | | Clofibric |
|---|---|---|---|---|---|---|---|
| PPCPs | Ibuprofen | Diclofenac | Diazepam | Iopromide | Meprobamate | Primidone | acid |
| Concentration | 100 | 100 | 100 | 100 | 100 | 100 | 100 |
| before | | | | | | | |
| treatment | | | | | | | |
| Concentration | <0.1 | <0.1 | 4.3 | 4.7 | 3.9 | <0.1 | 3.1 |
| after treatment | | | | | | | |

The above Examples illustrate that this method utilizes an on-line electrochemical method to generate an oxidation synergy of H₂O₂ and O₃ to treat typical PPCPs that are difficult to degrade such as ibuprofen, diclofenac, and primidone and the like. This method has the following characteristics and advantages: it does not need to add chemical agents, so it will not produce secondary pollution; because of the low voltage and current density of the applied electric field, there is no potential safety hazard, such that the method is easy for practical application; this method has a very good removal effect on COD and ammonia-nitrogen, and it is low in cost, economical and applicable, which makes it an efficient and rapid method for removing low concentration PPCPs. In addition, the overall structure of the reaction device also has good stability.

Although the present invention has been described above in detail with general description and specific embodiments, it is obvious to a person skilled in the art that some modifications or improvements can be made on the basis of the present invention. Therefore, changes, modifications, substitutions, combinations, and simplifications made without departing from the spirit and principle of the present invention fall within the protection scope of the present invention.

1. A method for removing pharmaceuticals and personal care products (PPCPs) in a drinking water treatment process, characterized in that the method comprises the following operations: introducing, by using a manner of bottom microporous aeration, a mixed gas of O₂ and O₃ in which a volume percentage of O₃ is 5% to 10% into an ozone contact column, at the bottom of which a cathode and an anode are disposed, and a direct current is applied to the cathode and the anode; while the mixed gas is being introduced, adding PPCPs-containing water to be treated to the ozone contact column, where the hydraulic retention time of 10 s to 40 min, and discharging water in real time;
the ratio of the amount of the introduced O₃ to the volume of the water to be treated is 0.1 to 10 mg/L, and the current density at the cathode is 0.1 to 20 mA/cm².

2. The method according to claim 1, characterized in that the PPCPs comprise one or more of ibuprofen, diclofenac, diazepam, iopromide, meprobamate, primidone, and clofibric acid.

3. The method according to claim 1, characterized in that the water to be treated is surface water or groundwater; wherein the concentration of the PPCPs is 0.01 ng/L to 20 mg/L, TOC is 0 to 10 mg/L, pH is 2 to 12, and the conductivity is greater than 300 μS/m.

4. The method according to claim 3, characterized in that the water to be treated is surface water or groundwater; wherein the concentration of the PPCPs is 2 ng/L to 100 ng/L, TOC is 0 to 6.3 mg/L, pH is 4.0 to 10.5, and the conductivity is greater than 300 μS/m.

5. The method according to claim 1, characterized in that the mixed gas is prepared by the following method: introducing O₂ into an ozone generator to obtain a mixed gas of O₂ and O₃ in which a volume percentage of O₃ is 5% to 10%.

6. The method according to claim 1, characterized in that in the electrodes, the anode area is 5 cm² to 20 cm², and the anode is selected from the group consisting of Pt electrode, graphite electrode, boron-doped diamond electrode, Pt/C electrode, ruthenium-iridium-plated titanium electrode, ruthenium-plated titanium electrode, platinum-plated titanium electrode, iridium-plated titanium-based electrode, rhodium-plated titanium-based electrode, iridium dioxide-plated titanium-based electrode, stainless steel electrode, nickel electrode, and alloy electrode containing two or more transition metals; the alloy electrode containing two or more transition metals is an aluminum alloy electrode, a titanium alloy electrode, a copper alloy electrode or a zinc alloy electrode; the cathode area is 5 cm² to 20 cm²; the cathode is selected from the group consisting of graphite electrode, glassy carbon electrode, activated carbon fiber electrode and gas diffusion electrode; the gas diffusion electrode is carbon paper/cloth/felt-polytetrafluoroethylene electrode, activated carbon-polytetrafluoroethylene electrode, carbon black-polytetrafluoroethylene electrode, carbon nanotube-polytetrafluoroethylene electrode, or graphene-polytetrafluoroethylene electrode.

7. The method according to claim 6, characterized in that, the anode is a Pt plate electrode or a ruthenium-iridium-plated titanium electrode with an area of 20 cm²; and the cathode is a carbon paper-polytetrafluoroethylene electrode, a carbon black-polytetrafluoroethylene electrode, or a graphite electrode with an area of 20 cm².

8. The method according to claim 1, characterized in that the method comprises the following operations: introducing O₂ into an ozone generator to obtain a mixed gas of O₂ and O₃ in which a volume percentage of O₃ is 5% to 10%, continuously and uniformly introducing, by using a manner of bottom microporous aeration, the mixed gas to an ozone contact column, at the bottom of which a cathode and an anode are disposed and a direct current is continuously applied to the cathode and the anode; while the mixed gas is being introduced, continuously adding PPCPs-containing water to be treated to the ozone contact column at a constant rate, with a hydraulic retention time of 10 to 20 min, and discharging the water in real time;
the ratio of the amount of the introduced O₃ to the volume of the water to be treated is 1.8 to 6.2 mg/L;
the anode is a Pt plate electrode or a ruthenium-iridium-plated titanium electrode with an area of 20 cm²; the cathode is a carbon paper-polytetrafluoroethylene electrode, a carbon black-polytetrafluoroethylene electrode, or a graphite electrode with an area of 20 cm²; and the current density at the cathode is 3 to 7 mA/cm².

9. The method according to claim 1, wherein one or more operations among introducing the mixed gas into the ozone contact column, applying direct current to the electrodes at two ends, adding the water to be treated to the ozone contact column, and discharging the water, are carried out intermittently.

10. A method for producing drinking water comprising implementing the method for removing PPCPs according to claim 1.
